(19) United States
(12) Patent Application Publication
(10) Pub. No.: US 2023/0334351 A1
(43) Pub. Date: Oct. 19, 2023

(54) NORMALIZED TECHNIQUES FOR THREAT EFFECT PAIRING

(71) Applicant: Raytheon Company, Waltham, MA (US)

(72) Inventors: Paul C. Hershey, Ashburn, VA (US); Brianne R. Hoppes, Westminster, CO (US); Kyle K. Ottinger, Aurora, CO (US); Bryan R. Harris, MADISON, AL (US); James E. Parry, NEW MARKET, AL (US)

(21) Appl. No.: 17/721,896

(22) Filed: Apr. 15, 2022

(51) Int. Cl. G06N 7/00; F41G 7/22; F41G 7/30

(52) U.S. Cl. CPC G06N 7/005; F41G 7/224; F41G 7/301

(57) ABSTRACT

Systems, devices, methods, and computer-readable media for normalized (threat, effect) pair algorithm generation. A method can include, for a defined scenario, identifying (threat, effect) pairs and for each (threat, effect) pair of the identified (threat, effect) pairs categorizing metrics of an algorithm, the algorithm indicating a probability of mitigating damage, by the effect, caused by the threat and generating a normalized algorithm for the identified (threat, effect) pair based on the metrics, the normalized algorithm operating based on input parameters of same units as other normalized algorithms. The method can include operating generated normalized algorithms resulting in respective probabilities and corresponding confidence intervals, combining the probabilities and confidence intervals to provide an overall probability and corresponding confidence intervals of mitigating identified threats of the identified (threat, effect) pairs using the identified effects of the identified (threat, effect) pairs, and deploying effects to mitigate the threats.

### BACKGROUND

When assessing the success of one or more effects (e.g., kinetic effects, non-kinetic effects, or a combination thereof) against threats (e.g., kinetic threats, non-kinetic threats, or a combination thereof) a mathematical characterization of such effect-threat pairings helps to achieve an objective assessment of the effectiveness of the effects. The effectiveness can include success of those effects neutralizing the threats to which they are paired.

Threats evolve, and as a threat evolves the form of a model of the threat typically changes. Also, for different given threats, the form of the model of the threat is generally different. A normalized form for various, different, and evolving models would help compatibility, understandability, deployment, and would help reduce complexity.

There are many algorithms for determining a threat-danger assessment. However, these algorithms are specific to a given (threat, effect) pairing and apply to a specific scenario (e.g., Concept of Operations (CONOPS) or Concept of Employment (COE)), and to a specific mission phase. For the example of Joint All Domain Command and Control (JADC2) or missile defense these phases can include manufacturing, fielding and deployment, boost, midcourse, and terminal. Presently, to the best of the knowledge of the inventors, there is no method or technique to assure that results of these diverse assessment algorithms can be combined in a meaningful way to provide an overall mission assessment. This issue impacts mission effectiveness and impedes successful execution of the mission in a timely manner.

### BRIEF DESCRIPTION OF DRAWINGS

FIG. 1 illustrates, by way of example, a diagram of an embodiment of an operation view of combined cyber, electronic warfare, and kinetic effects responding to defeat disparate threats over the threat kill chain.

FIG. 2 illustrates, by way of example, a diagram of an embodiment of a method for normalization of algorithms and establishing a database of normalized (threat, effect) pairs.

FIG. 3 illustrates, by way of example, a diagram of an embodiment of a method for algorithm normalization.

FIG. 4 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims,

Embodiments provide techniques for making threat effect analyses compatible, such as by normalizing algorithms for threat-effect pairings. For example, generally disparate, non-comparable results are typically provided from different (threat, effect) pair models. Each (threat, effect) pair model provides results in units that are meaningful in a specific domain. For example, a model that determines an effect of an Upper Tier (UT) missile, Middle Tier (MT) missile. Lower Tier (LT) missile, mobile and ground radar, and directed energy (DE) weapon, respectively, on a threat, takes input in a different form and provides output of a different form, respectively. By normalizing the algorithms (more details elsewhere) the results of the algorithms can be easily combined, such as by addition, to simulate various combinations of (threat, effect) pairs. Normalizing the algorithms converts algorithm results for (threat, effect) pairs into equivalent units (e.g., for UT, MT, LT, mobile and ground radar, and DE (threat, effect) pairs).

Normalizing algorithms provides an algorithm construction framework that enables the creation of (threat, effect) pairable algorithms such that, when populated with data, the results can be compared and combined for the same tasks and for varying tasks (e.g., with respect to metric units, magnitudes, dimensions, a combination thereof or the like). Combining algorithm results from different, normalized algorithms helps provide mission assessment based on sharing intermediate products (e.g., confidence intervals). Normalized algorithms can be stored in a repository of unique algorithms for mission assessment with a definite analytic discriminator.

Embodiments are described generally with regard to projectiles, radar, cyber, and DE type threats and effects, but can include other threats and effects. The threats can be kinetic, such as to inflict damage through object motion through air. The threats can be non-kinetic, such as to inflict damage through a medium other than motion through air, such as electrical, chemical, social, or the like. Similarly, the effects can be kinetic or non-kinetic, but instead of inflicting damage, the effects mitigate the damage. A goal of a mission can generally be to reduce damage inflicted on an entity performing mission planning.

Embodiments can help aid a mission planner in determining which effects to deploy to physically mitigate the effects. Embodiments can do this by normalizing the algorithms in a way that allows results of the algorithms to be combined with simple mathematical operations. Other advantages of such normalization are realized and described herein.

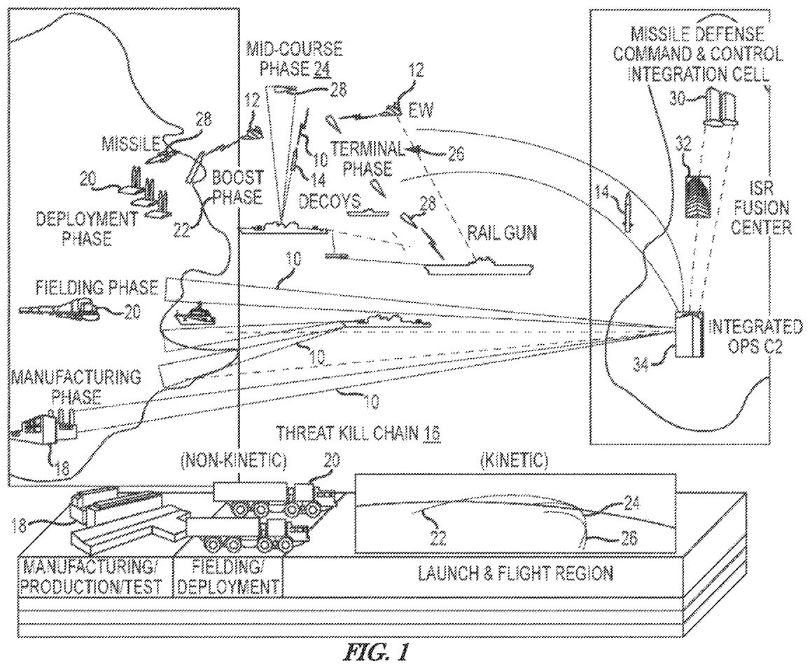

FIG. 1 depicts, by way of example, a block diagram of an embodiment of a threat kill chain 16. The threat kill chain 16 includes integration and synchronization of cyber, electronic warfare and kinetic effects 10, 12 and 14, respectively, to negate vulnerabilities in the threat kill chain 16 including manufacturing/production/test stage 18 and fielding and deployment stage 20 “left of launch” and boost, mid-course and terminal phases 22, 24 and 26 “right of launch” for an active missile threat 28. A missile defense command & control integration cell 30, ISR (Intelligence, Surveillance and Reconnaissance) fusion center 32 and Integrated Ops C2 34 coordinate the selection (and possible modification) and execution of a combined effects scenario to engage and defeat the active missile threat 28. The cyber, electronic warfare and kinetic effects can be launched from local or remote land, sea, air, and space-based platforms.

An example of a non-kinetic effect can include electrically taking the manufacturing/production/test stage 18 offline, altering a vehicle used for deployment 18, otherwise interfering with the manufacture and deployment of the missile 28, electronic warfare (EW) interference with the missile 28, a decoy missile that does not explode, or the like. Examples of kinetic effects can include a decoy projectile that explodes, a defensive projectile that physically contacts the missile 28, a cruise missile, a Standard Missile 3 (SM3), and a Standard Missile 6 (SM6), a bomb such as the Small Diameter Bomb (SDB), or the like.

Generally, different effects and different threats have distinct models that operate based on different input variables and generate results in differing form, units, and purpose. For example, respective algorithms to determine operation of a UT missile, MT missile, LT missile, radar, and DE operate on different inputs and generate results in a form that is different.

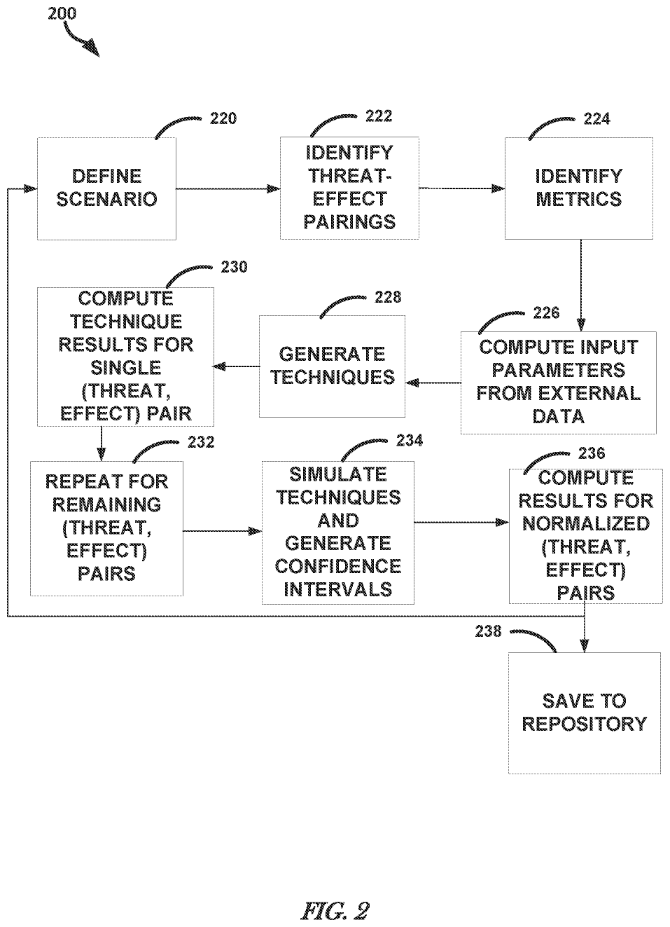

FIG. 2 illustrates, by way of example, a diagram of an embodiment of a method 200 for normalization of algorithms and establishing a database of normalized (threat, effect) pairs. At operation 220, a scenario is defined. Defining a scenario includes establishing a region of operation, identifying threats, identifying effects, identifying possible targets for the threats, determining a timeline of operation, or the like. In general, the operation 220 can include defining a concept of operations (CONOPS).

At operation 222 (threat, effect) pairs can be identified. A (threat, effect) pair includes an individual threat (e.g., an adversarial object or adversarial entity) that can damage an asset (e.g., a friendly entity or friendly object) and an individual effect (e.g., a friendly entity or friendly object that can help mitigate the damage inflicted by the threat. Not all threats and effects are compatible. A compatible (threat, effect) pair is one in which the effect can help mitigate damage from the threat. Any effect that does not help mitigate the damage from the threat is not compatible with the threat. The operation 222 can include identifying compatible (threat, effect) pairs.

At operation 224, metrics of identified (threat, effect) pairs are identified. The metrics are input parameters that are used by algorithms of the (threat, effect) pairs. The operation 224 can include categorizing the metrics so as to put each of the metrics into a category. The categorizing can allow for generalization of metrics and allow for normalization across the algorithms.

At operation 226, input parameters can be computed. The input parameters can be computed based on external data. The input parameters can include actual values for the metrics of the algorithms. The values of the input parameters can be converted to same units. Same units allow the output of the algorithm and the input parameters to be comparable, combinable, and consistent.

The operations 224 and 226 for UT, MT, and LTP can include time in track (sensor coverage duration, or the time where TARGET AccelX+AccelY+AccelZ zero out, add 30 s to get an assumed track start time, number of samples (NSamples) that are assumed 1/sec=time in track); track position error (“Ep”, Ep=max(range_in_meters*sqrt(4/NSamples)*1.1, 100); track velocity error (“Ev”, Ev=max(range_in_meters*sqrt(12/NSamples)/timeInTrack*1.1, 10); closing velocity (“Vc”, where position difference, posDiff=posInterceptor−posThreat vector), velocity difference, velDiff=velInterceptor−velThreat (3D vector), Vc=−1*velDiff.dot(posDiff)/mag(posDiff); acquisition range (“Ra”, assume 25000 m (25 km) for UT, 60000 m (60 km) for MT, 50 km for LT (conversion from km to m done in the equation); and time of burnout (“Tb”, If burnout state is not available the time of intercept minus the time when interceptor Accel X+Accel Y+Accel Z zero out−or take the intercept time minus the time when rss(velX, velY, velZ) are maxed, (RSS=root-sum-squared, square all the terms, add them, then take the square root).

The operations 224 and 226 for LT2 and LT6 can include computing target velocity and cross angle from last three states (position, velocity) of interceptor (effect) and target (threat) with a target velocity vector provided. Note crossing angle=180−(angle between target and interceptor velocity vectors for the same timestamp). Cross_Ang is target crossing angle. It serves the purpose of reducing Pk when the target gets lost in clutter due to not having a Doppler return if its velocity, vector is 90 degrees to the radar. Nominal values of Q_err=400. Q_err is an input that would represent the size of the basket of uncertainty that the missile seeker would have to search through to find the target. Q_err is supposed to be something sent to the missile from the cueing radar. SrchTime=40. SrchTime represents how much time the missile has to search the uncertainty basket to find the target. If the missile has more time, then the odds of acquiring and tracking the target get better. CRMD=5. CRMD is a measure of how much the target is maneuvering. The more it maneuvers, the more energy will be spent compensating for the maneuvers, which slows the missile down and makes it more difficult to hit the target.

The operations 224 and 226 for radar can include inputs range (“Ra”) in kilometers. Signal to Noise Ratio (SNR)—use provided SNR. Atgt (Radar Cross-Section) Assume nominal value. Target Velocity—use provided values either for target velocity, or compute from azimuth, elevation, and angle rates. Output is TLE=30*(1−R*A*SNR/MaxSNR). Target velocity can be determined using range (m), range rate (m/s), azimuth rate (deg/s), elevation rate. R can be derived from Rtgt=Ra=target acquisition range (m). A can be derived from radar cross section (RCS). R=1−(e^{[-9+0.4*Rtgt]}/(1+e^{[-9+0.4*Rtgt])) and A=}1−0.001^{(RCS+0.01)}.

The operations 224 and 226 for DE can include Aspect Angle—compute from DE emplacement boresight to find the central angle between [az, el]; Target Range—use provided value; Q_err—use off boresight angles, (where it would start losing gain) Q_err is meant to be [0 1], so scale to this range; T_dwl—for DE propose nominal value to get Pk in the desired range. Microwave is instantaneous. This is more appropriate for laser (heat up target).

At operation 228, a normalized algorithm for quantifying a probability of kill (Pkill) based on the identified metrics from operation 224 and the computed input parameters from operation 226 can be generated. The normalized algorithm can take a specified form. The normalized algorithm can operate on input parameters with specified units and produce output with specified units. The normalized form for a DE effect can be as follows:

Pk=A*R*T*Q Equation 1

The default value for a given input parameter (e.g., A, R, I, Q, . . . ) can be one (1). That way, if a given input parameter is not used for the given algorithm, the result is not affected as a unity multiplication does not change the result. More details regarding the normalized form and how to operate using the normalized algorithm are provided elsewhere.

The normalized algorithm can include parameters for both kinetic (projectiles) and non-kinetic (radar and DE). The normalized algorithm can express Pk as a function of the identified input parameters: Pk=F(A, R, T, Q, V). The actual algorithm for the unique threat effect pair can use some or all of the input parameters that are part of the function.

At operation 230, the generated algorithm can be used to provide results for a single (threat, effect) pair. The operation 230 can include using the input parameters to generate a result using the normalized algorithm from operation 228.

Operations 226, 228, and 230 can be repeated for each remaining (threat, effect) pair identified at operation 322. The operation 322 can normalize the algorithms for determining a probability (Pkill) of mitigating damage from the threat.

At operation 234 the normalized algorithms can be simulated to generate a series of results. The series of results can be used to generate confidence intervals for a total Pkill that quantifies Pkill for a combination of the (threat, effect) pairs based on the normalized algorithms. The operation 234 can include performing a Monte Carlo simulation. Monte Carlo simulations are used to predict outcomes and confidence intervals when a random variable is present. A Monte Carlo simulation takes the variable that has uncertainty and assigns it a random value. The model is then run and a result is provided. This process is repeated again and again while assigning the variable in question with many different values. After the simulation is complete, the results are averaged together to provide an estimate that includes both Pkill and the associated confidence interval that represents the variability in the Pkill results.

The results of normalized (threat, effect) pairs are computed at operation 236. The operation 236 includes operating on the results of the Monte Carlo simulations to determine a total Pkill and the associated confidence interval.

At operation 238, the results, scenario, identified (threat, effect) pairs, identified metrics, normalized algorithms, input parameters, or a combination thereof can be stored. The operation 238 provides efficiency for a future, repeated scenario or future similar scenario. Instead of performing the method 200 to generate results, a future scenario can leverage the results, scenario, identified (threat, effect) pairs, identified metrics, normalized algorithms, input parameters, or a combination thereof from a repository of previous simulations.

The method 200, through operation 228, generates normalized algorithms for (threat, effect) pairs. Normalized algorithms from the method 200 for various (threat, effect) pairs are now provided.

For a UTI missile threat and interceptor effect the normalized algorithm accepts geometry and target parameters and returns Pk value between 0 and 1. The normalized algorithms trends appropriately with input variations. Inputs are provided in form [min, max] or [nom]. Ep=Track Position Error*(m, 3σ)−[0, 10k]; Ev=Track Velocity Error*(m/s, 3σ)−[0, 300]; Vc=Closing Velocity at intercept (m/s)−[1k, 10k]; Ra=Acquisition range (m)−[50k, 500k]; K=knockdown factor=0.9; Etot=Ep/3+Ev/3*(Ra/Vc+30).

$${Pk}_{UT} = \{ \begin{matrix}if Etot == 0 \to K \\ else : K * ( 1 - {e}^{( 1 - M )} ) ⋆ ( 1 - {e}^{- N} )\end{matrix}$$

Where

$$M = {( \frac{Ra}{Vc} ⋆ 400 )}^{2} / ( 2 ⋆ {Etot}^{2} )$$

and N=(Ra*Tan(0.06))²/(2*Etot²).

For an MT3 missile threat and interceptor effect the normalized algorithm accepts geometry and target parameters and returns Pk value between 0 and 1. The normalized algorithms trends appropriately with input variations. Inputs are provided in form [min, max] or [nom]. Ep=Track Position Error*(m, 3σ)−[0, 10k]. Ev=Track Velocity Error*(m/s, 3σ)−[0, 300]. Tb=Tgo at last burn (s)−[0, 300]. Vc=Closing Velocity at intercept (m/s)−[1k, 10k]. Ra=Acquisition range (m)−[50k, 500k]. K=knockdown factor=0.9. Etot=Ep/3+Ev/3*(Tb+30).

$${Pk}_{MT 3} = \{ \begin{matrix}if Etot == 0 \to K \\ else : K * ( 1 - {e}^{( 1 - M )} ) ⋆ ( 1 - {e}^{- N} )\end{matrix}$$

Where

$$M = {( \frac{Ra}{Vc} ⋆ 200 )}^{2} / ( 2 ⋆ {Etot}^{2} )$$

and N=(Ra*Tan(0.07))²/(2*Etot²).

For an LT1 missile threat and interceptor effect the normalized algorithm accepts geometry and target parameters and returns Pk value between 0 and 1. The normalized algorithms trends appropriately with input variations. Inputs are provided in form [min, max] or [nom]. Ep=Track Position Error*(m, 3σ)−[0, 2k]. Ev=Track Velocity Error*(m/s, 3σ)−[0, 50]. Te=Tgo at KV eject (s)−[10, 30]. Ra=Acquisition range (km)[50, 200].

$${Pk}_{LT 1} = \{ \begin{matrix}if Ep == 0 \to 1 \\ else : ( 1 - {e}^{- M} ) ⋆ ( 1 - {e}^{- N} )\end{matrix}$$

Where

$$M = Te * 50 / {( \frac{Ep}{3} + \frac{Ev}{3} * Te )}^{2} and$$

$$N = {( Ra ⋆ 1000 * Tan ( 1. ) )}^{2} / {( \frac{Ep}{3} + \frac{Ev}{3} * Te )}^{2} .$$

For an LT2 missile threat and interceptor effect the normalized algorithm accepts geometry and target parameters and returns Pk value between 0 and 1. The normalized algorithms trends appropriately with input variations. Inputs are provided in form [min, max] or [nom]. Ep=Track Position Error*(m, 3σ)−[0, 2k]. Ev=Track Velocity Error*(m/s, 3σ)−[0, 50]. Te=Tgo at KV eject (s)−[10, 30]. Ra=Acquisition range (km) [50, 200].

$${Pk}_{LT 2} = \{ \begin{matrix}if Ep == 0 \to 1 \\ else : K * ( 1 - {e}^{- M} ) ⋆ ( 1 - {e}^{- N} )\end{matrix}$$

Where

$$M = {( Te * 50 )}^{2} / {( \frac{Ep}{3} + \frac{Ev}{3} * Te )}^{2} and$$

$$N = {( Ra ⋆ 1000 * Tan ( 1. ) )}^{2} / {( \frac{Ep}{3} + \frac{Ev}{3} * Te )}^{2} .$$

For an LT6 missile threat and interceptor effect the normalized algorithm accepts geometry and target parameters and returns Pk value between 0 and 1. The normalized algorithms trends appropriately with input variations. Inputs are provided in form [min, max] or [nom]. Q_err=Cueing Error (m)−[0,1000]. SrchTime—Time allowed to search for target (s). V_Tgt—Target Velocity (m/s) [0,1000]. CRMD (m) Cross range maneuver distance. Cross_Ang—Target Crossing angle (deg).

For a mobile threat and mobile radar effect, the normalized algorithm accepts geometry and target parameters and returns Pk value between 0 and 1. The normalized algorithms trends appropriately with input variations. Inputs are provided in form [min, max] or [nom]. Ra=Target Acquisition Range (m)−[0,250]. Vtgt=Target Velocity (m/s)−[0,20]. RCS=Target Radar Cross-Section Area (m2)−[0,5]. SNR=Signal to Noise Ratio−[0, SNRMax].

Pk_{track}=V*R*A

Where

$$V = {e}^{( \text{.4} * Vtgt ) / ( 1 +} {e}^{( \text{.4} * Vtgt )} ) ,$$

$$R = 1 - {e}^{( - 9 + \text{.4} * Rtgt ) / ( 1 +} {e}^{( 9 + \text{.4} * Rtgt )} ) ,$$

$$A = 1 - {0.001}^{( RCS + 0.1 )} ,$$

$$and TLE = 30 * ( 1 - R * A ( \frac{S N R}{S N R Max} ) ) .$$

For a stationary threat and mobile radar effect, the normalized algorithm accepts geometry and target parameters and returns Pk value between 0 and 1. The normalized algorithms trends appropriately with input variations. Inputs are provided in form [min, max] or [nom]. Ra=Target Acquisition Range (m)−[0,250]. Atgt=Target Cross-Sectional Area (m2)−[0,5]. SNR=Signal to Noise Ratio−[0, SNRMax].

Pk_{track}=R*A

Where

$$R = 1 - {e}^{( - 9 + \text{.4} * Rtgt ) / ( 1 +} {e}^{( 9 + \text{.4} * Rtgt )} ) ,$$

$$A = 1 - {0.001}^{( Atgt + 0.1 )} ,$$

$$and TLE = 30 * ( 1 - R * A ( \frac{S N R}{S N R Max} ) ) .$$

For a combined mobile and stationary threat and mobile radar effect, the normalized algorithm accepts geometry and target parameters and returns Pk value between 0 and 1. The normalized algorithms trends appropriately with input variations. Inputs are provided in form [min, max] or [nom]. Ra=Target Acquisition Range (m)−[0,250]. Vtgt=Target Velocity (m/s)−[0,20]. RCS=Target Radar Cross-Section Area (m2)−[0,5]. SNR=Signal to Noise Ratio−[0, SNRMax].

Pk_{track}=V*R*A

Where

$$V = {e}^{( \text{.4} * Vtgt ) / ( 1 +} {e}^{( \text{.4} * Vtgt )} ) / 2 ,$$

$$R = 1 - {e}^{( - 9 + \text{.4} * Rtgt ) / ( 1 +} {e}^{( 9 + \text{.4} * Rtgt )} ) ,$$

$$A = 1 - {0.001}^{( RCS + 0.1 )} ,$$

$$and TLE = 30 * ( 1 - R * A ( \frac{S N R}{S N R Max} ) ) .$$

For a combined mobile and stationary threat and stationary radar effect, the normalized algorithm accepts geometry and target parameters and returns Pk value between 0 and 1. The normalized algorithms trends appropriately with input variations. Inputs are provided in form [min, max] or [nom]. Ra=Target Acquisition Range (m)−[0,250]. Vtgt=Target Velocity (m/s)−[0,20]. RCS=Target Radar Cross-Section Area (m2)−[0,5]. SNR=Signal to Noise Ratio−[0,2].

Pk_{track}=V*R*A

Where

$$V = ( 1 + {e}^{( \text{.4} * Vtgt ) / ( 1 +} {e}^{( \text{.4} * Vtgt )} ) ) / 2 ,$$

$$R = 1 - {e}^{( - 9 + \text{.4} * Rtgt * Rscale ) / ( 1 +} {e}^{( 9 + \text{.4} * Rtgt * RScale )} ) ,$$

$$A = 1 - {0.001}^{( RCS * AScale + 0.1 )} ,$$

$$and TLE = 30 * ( 1 - R * A ( \frac{S N R}{S N R Max} ) ) .$$

AScale and RScale are normalization factors.

For a DE effect threat, the normalized algorithm accepts geometry and target parameters and returns Pk value between 0 and 1. The normalized algorithms trends appropriately with input variations. Inputs are provided in form [min, max] or [nom]. A_ang−Aspect angle [0, 90]. R_Tgt—Range to target [0, 250]. Q_err—Angle error [0, 1]. T_dwl—Dwell time of laser on target [0, 10].

Pk_{DE}=R*A*T*Q

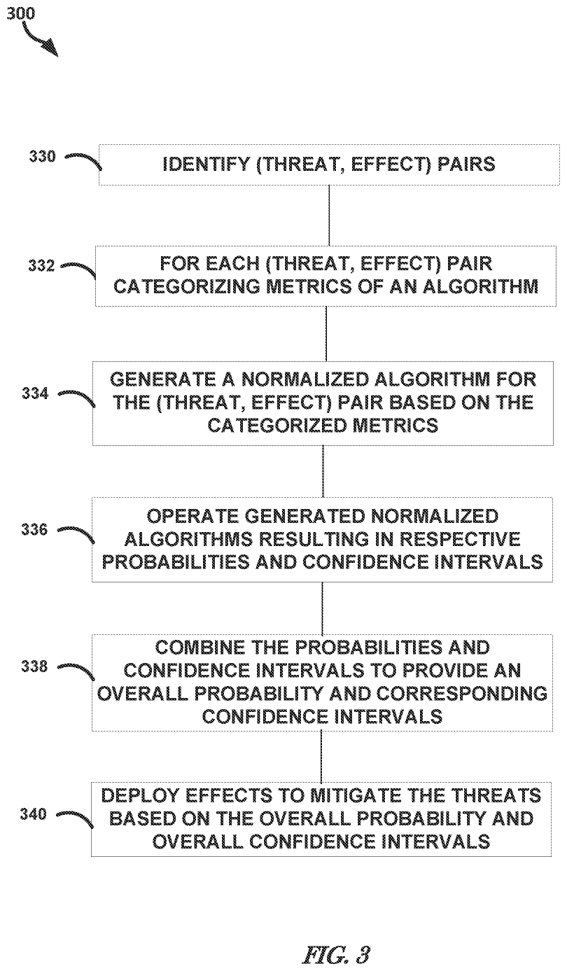

FIG. 3 illustrates, by way of example, a diagram of an embodiment of a method 300 for threat mitigation by probability normalization. The method 300 as illustrated includes for a defined scenario, identifying (threat, effect) pairs, at operation 330; for each (threat, effect) pair of the identified (threat, effect) pairs categorizing metrics of an algorithm (the algorithm indicating a probability of mitigating damage, by the effect, caused by the threat), at operation 332; generating a normalized algorithm for the identified (threat, effect) pair based on the metrics (the normalized algorithm operating based on input parameters of same units as other normalized algorithms), at operation 334; operating generated normalized algorithms resulting in respective probabilities and corresponding confidence intervals, at operation 336; combining the probabilities and confidence intervals to provide an overall probability and corresponding confidence intervals (of mitigating identified threats of the identified (threat, effect) pairs using the identified effects of the identified (threat, effect) pairs), at operation 338; and deploying effects to mitigate the threats based on the overall probability and overall confidence intervals, at operation 340.

The operation 330 can include identifying only (threat, effect) pairs for which the effect has a non-zero probability of mitigating damage of the threat. The threats can include a missile and the effects include an interceptor, radar, cyber effect, or directed energy device. The operation 334 can include performing a Monte Carlo simulation including each of the generated normalized algorithms.

The method 300 can further include storing the identified input parameters, generated normalized algorithms, probabilities, and confidence intervals in a database indexed by (threat, effect) pair. The method 300 can further include, for a different scenario, querying the database for the input parameters, generated normalized algorithms, probabilities, and confidence intervals in a database indexed by (threat, effect) pair and refraining from re-generating the generated normalized algorithms. The method 300 can further include identifying the input parameters, the input parameters quantify the metrics. The metrics can include probability of scenario success (Psuccess), monetary cost, collateral damage, attribution, minimum amount of supplies, minimum amount of personnel, probability of kill (Pkill or Pk), probability of damage (Pdamage), probability of target (Ptgt), minimum bandwidth, or maximum communications latency. The input parameters can include time in track, track position error, track velocity error, closing velocity, acquisition range, and time of burnout.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carder, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

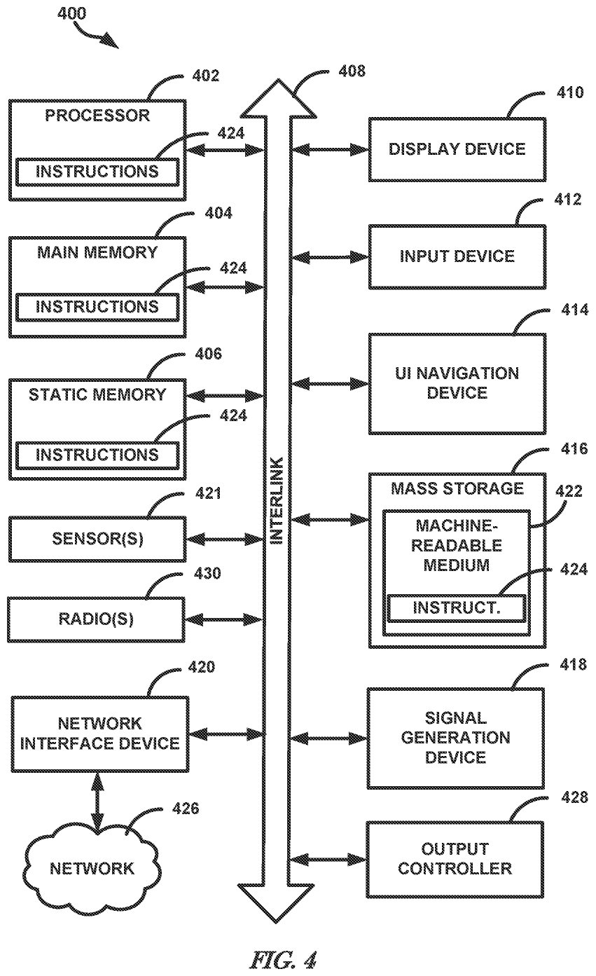

FIG. 4 illustrates, by way of example, a block diagram of an embodiment of a machine in the example form of a computer system 400 within which instructions, for causing the machine to perform any one or more of the methodologies discussed herein, may be executed. One or more of the methods 200, 300 can be implemented or performed by the computer system 400. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 421 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker), a network interface device 420, and radios 430 such as Bluetooth, WWAN, WLAN, and NFC, permitting the application of security controls on such protocols.

The machine 400 as illustrated includes an output controller 428. The output controller 428 manages data flow to/from the machine 400. The output controller 428 is sometimes called a device controller, with software that directly interacts with the output controller 428 being called a device driver.

### Machine-Readable Medium

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404, the static memory 406, and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Additional Example

Example 1 can include a method for threat mitigation by probability normalization, the method comprising for a defined scenario, identifying (threat, effect) pairs, for each (threat, effect) pair of the identified (threat, effect) pairs categorizing metrics of an algorithm, the algorithm indicating a probability of mitigating damage, by the effect, caused by the threat, generating a normalized algorithm for the identified (threat, effect) pair based on the metrics, the normalized algorithm operating based on input parameters of same units as other normalized algorithms, operating generated normalized algorithms resulting in respective probabilities and corresponding confidence intervals, combining the probabilities and confidence intervals to provide an overall probability and corresponding confidence intervals of mitigating identified threats of the identified (threat, effect) pairs using the identified effects of the identified (threat, effect) pairs, and deploying effects to mitigate the threats based on the overall probability and overall confidence intervals.

In Example 2, Example 1 can further include, wherein identifying (threat, effect) pairs includes identifying only (threat, effect) pairs for which the effect has a non-zero probability of mitigating damage of the threat.

In Example 3, at least one of Examples 1-2 can further include, wherein the threats include a missile and the effects include an interceptor, radar, cyber effect, or directed energy device.

In Example 4, at least one of Examples 1-3 can further include, wherein operating the generated normalized algorithms includes performing a Monte Carlo simulation including each of the generated normalized algorithms.

In Example 5, at least one of Examples 1-4 can further include storing the identified input parameters, generated normalized algorithms, probabilities, and confidence intervals in a database indexed by (threat, effect) pair, and for a different scenario, querying the database for the input parameters, generated normalized algorithms, probabilities, and confidence intervals in a database indexed by (threat, effect) pair and refraining from re-generating the generated normalized algorithms.

In Example 6, at least one of Examples 1-5 can further include identifying the input parameters, the input parameters quantify the metrics.

In Example 7, Example 6 can further include, wherein the metrics include probability of scenario success, monetary cost, collateral damage, attribution, minimum amount of supplies, minimum amount of personnel, probability of kill, probability of damage, probability of target, minimum bandwidth, or maximum communications latency.

In Example 8, Example 7 can further include, wherein the input parameters include time in track, track position error, track velocity error, closing velocity, acquisition range, and time of burnout.

Example 9 can include a non-transitory machine-readable medium including instructions that, when executed by a machine, cause the machine to perform the method of one of Examples 1-8.

Example 10 can include a system comprising processing circuitry, a memory including instructions that, when executed by the processing circuitry, cause the processing circuitry to perform the method of one of Examples 1-8.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for threat mitigation by probability normalization, the method comprising:
for a defined scenario, identifying (threat, effect) pairs;
for each (threat, effect) pair of the identified (threat, effect) pairs:
categorizing metrics of an algorithm, the algorithm indicating a probability of mitigating damage, by the effect, caused by the threat;
generating a normalized algorithm for the identified (threat, effect) pair based on the metrics, the normalized algorithm operating based on input parameters of same units as other normalized algorithms;
operate generated normalized algorithms resulting in respective probabilities and corresponding confidence intervals;
combining the probabilities and confidence intervals to provide an overall probability and corresponding confidence intervals of mitigating identified threats of the identified (threat, effect) pairs using the identified effects of the identified (threat, effect) pairs; and
deploying effects to mitigate the threats based on the overall probability and overall confidence intervals.

2. The method of claim 1, wherein identifying (threat, effect) pairs includes identifying only (threat, effect) pairs for which the effect has a non-zero probability of mitigating damage of the threat.

3. The method of claim 1, wherein the threats include a missile and the effects include an interceptor, radar, cyber effect, or directed energy device.

4. The method of claim 1, wherein operating the generated normalized algorithms includes performing a Monte Carlo simulation including each of the generated normalized algorithms.

5. The method of claim 1, further comprising:
storing the identified input parameters, generated normalized algorithms, probabilities, and confidence intervals in a database indexed by (threat, effect) pair; and
for a different scenario, querying the database for the input parameters, generated normalized algorithms, probabilities, and confidence intervals in a database indexed by (threat, effect) pair and refraining from re-generating the generated normalized algorithms.

6. The method of claim 1, further comprising identifying the input parameters, the input parameters quantify the metrics.

7. The method of claim 6, wherein the metrics include probability of scenario success, monetary cost, collateral damage, attribution, minimum amount of supplies, minimum amount of personnel, probability of kill, probability of damage, probability of target, minimum bandwidth, or maximum communications latency.

8. The method of claim 7, wherein the input parameters include time in track, track position error, track velocity error, closing velocity, acquisition range, and time of burnout.

9. A non-transitory machine-readable medium including instructions that, when executed by a machine, cause the machine to perform operations for threat mitigation by probability normalization, the operations comprising:
for a defined scenario, identifying (threat, effect) pairs;
for each (threat, effect) pair of the identified (threat, effect) pairs:
categorizing metrics of an algorithm, the algorithm indicating a probability of mitigating damage, by the effect, caused by the threat;
generating a normalized algorithm for the identified (threat, effect) pair based on the metrics, the normalized algorithm operating based on input parameters of same units as other normalized algorithms;
operate generated normalized algorithms resulting in respective probabilities and corresponding confidence intervals;
combining the probabilities and confidence intervals to provide an overall probability and corresponding confidence intervals of mitigating identified threats of the identified (threat, effect) pairs using the identified effects of the identified (threat, effect) pairs; and
deploying effects to mitigate the threats based on the overall probability and overall confidence intervals.

10. The non-transitory machine-readable medium of claim 9, wherein identifying (threat, effect) pairs includes identifying only (threat, effect) pairs for which the effect has a non-zero probability of mitigating damage of the threat.

11. The non-transitory machine-readable medium of claim 9, wherein the threats include a missile and the effects include an interceptor, radar, cyber effect, or directed energy device.

12. The non-transitory machine-readable medium of claim 9, wherein operating the generated normalized algorithms includes performing a Monte Carlo simulation including each of the generated normalized algorithms.

13. The non-transitory machine-readable medium of claim 9, wherein the operations further comprise:
storing the identified input parameters, generated normalized algorithms, probabilities, and confidence intervals in a database indexed by (threat, effect) pair; and
for a different scenario, querying the database for the input parameters, generated normalized algorithms, probabilities, and confidence intervals in a database indexed by (threat, effect) pair and refraining from re-generating the generated normalized algorithms.

14. The non-transitory machine-readable medium of claim 9, wherein the operations further comprise identifying the input parameters, the input parameters quantify the metrics.

15. The non-transitory machine-readable medium of claim 14, wherein the metrics include probability of scenario success, monetary cost, collateral damage, attribution, minimum amount of supplies, minimum amount of personnel, probability of kill, probability of damage, probability of target, minimum bandwidth, or maximum communications latency.

16. The non-transitory machine-readable medium of claim 15, wherein the input parameters include time in track, track position error, track velocity error, closing velocity, acquisition range, and time of burnout.

17. A system comprising:
processing circuitry;
a memory including instructions that, when executed by the processing circuitry, cause the processing circuitry to perform operations for threat mitigation by probability normalization, the operations comprising:
for a defined scenario, identifying (threat, effect) pairs;
for each (threat, effect) pair of the identified (threat, effect) pairs:
categorizing metrics of an algorithm, the algorithm indicating a probability of mitigating damage, by the effect, caused by the threat;
generating a normalized algorithm for the identified (threat, effect) pair based on the metrics, the normalized algorithm operating based on input parameters of same units as other normalized algorithms;
operate generated normalized algorithms resulting in respective probabilities and corresponding confidence intervals;
combining the probabilities and confidence intervals to provide an overall probability and corresponding confidence intervals of mitigating identified threats of the identified (threat, effect) pairs using the identified effects of the identified (threat, effect) pairs; and
deploying effects to mitigate the threats based on the overall probability and overall confidence intervals.

18. The system of claim 17, wherein identifying (threat, effect) pairs includes identifying only (threat, effect) pairs for which the effect has a non-zero probability of mitigating damage of the threat.

19. The system of claim 17, wherein the threats include a missile and the effects include an interceptor, radar, cyber effect, or directed energy device.

20. The system of claim 17, wherein operating the generated normalized algorithms includes performing a Monte Carlo simulation including each of the generated normalized algorithms.
